(19) United States
(12) Patent Application Publication
(10) Pub. No.: US 2010/0271704 A1
(43) Pub. Date: Oct. 28, 2010

(54) DEVICE AND METHOD FOR BEAM FORMING A HOMOGENIZED LIGHT BEAM

(76) Inventors: Rainer Pätzel, Dransfeld (DE); Ludwig Schwenger, Hannover (DE)

Correspondence Address: Coherent, Inc. c/o Morrison & Forester, 425 Market Street, San Francisco, CA, 94105-2482, US

(21) Appl. No.: 12/743,269

(22) PCT Filed: Nov. 18, 2008
(86) PCT No.: PCT/DE08/01903

§ 371 Date: Jul. 15, 2010

(30) Foreign Application Priority Data
Nov. 19, 2007 (DE) 10 2007 055 215.9
Feb. 12, 2008 (DE) 10 2008 008 580.4

(51) Int. Cl. G02B 27/09

(52) U.S. Cl. 359/597

(57) ABSTRACT

Described is a device as well as a method for beam forming a homogenized light beam, particularly a laser beam, with a unit that homogenizes the light beam at least along a cross-sectional axis of the light beam, a mask following downstream in the beam path of the light beam, said mask having mask regions that block the light beam and those that are transparent, and also an optical imaging unit disposed downstream in the beam path.

The invention stands out on account of the fact that an optical module is provided in the beam path between the homogenizing unit and the mask, said module imaging the entire cross section of the homogenized light beam largely without losses onto all transparent mask regions with uniform distribution.

### TECHNICAL FIELD

The invention relates to a device and a method for beam forming a homogenized or a self-homogenizing light beam, particularly a laser beam, with a unit that homogenizes the light beam at least along a cross-sectional axis of the light beam, a mask following downstream in the beam path of the light beam, said mask having mask regions that block the light beam and those that are transparent, and also an optical imaging unit disposed downstream in the beam path.

### PRIOR ART

Generic devices for beam forming homogenized light beams are used in many industrial fields, thus, for example, for purposes of a structured light exposure of substrates of any desired type, in each case with the requirement to impinge upon the structural regions to be exposed to light with a homogeneously distributed light intensity. For example, reference may be made in this context to the technology of photolithography or photoablation. Optical homogenizers are used independently of the wavelength of the light beams to be homogenized in each case and it is also irrelevant whether the light beam is generated continuously or in a pulsed manner and is supplied in accordance with a further technical use.

In most technical use cases in which optical homogenizers are used, a mask arrangement is disposed in the beam path directly or indirectly downstream of the homogenizer, which mask arrangement geometrically limits the homogenized light beam in the beam cross section for purposes of its downstream technical use and thus undertakes beam forming. Typically, the overall beam cross section of the homogenized light beam exiting from the homogenizer hits a mask, which provides transparent mask regions and also mask regions which block the homogenized light beam, the shape and size of which mask regions are determined by a geometry specification which is dependent on the further technical application. Thus, only those beam portions of the light beam which make it onto the transparent mask regions, mostly in the form of gaps within the mask, make it through the mask. The remaining portion of the homogenized light beam remains technically unused. In practical use cases, in which the mask regions that block the light beam make up up to 99% of the cross section of the light beam, it becomes clear that merely 1% of the overall light energy is used for a technical use, the rest, by contrast, is lost.

An optical arrangement for affecting a light beam, which light beam is to be directed onto an object surface for processing, is to be drawn from U.S. Pat. No. 5,657,138. To this end, the light beam passes through diverse optical elements which image the light beam in the desired form onto a certain object for purposes of a targeted surface processing.

U.S. Pat. No. 5,473,408 describes a hollow integrator, from which a homogenized light beam emerges, which light beam impinges via optical imaging elements onto a mirrored diaphragm or mask arrangement which faces the light beam.

### DESCRIPTION OF THE INVENTION

The invention is based on the object of developing a device and also a method for beam forming a homogenized or a self-homogenizing light beam, particularly a laser beam, with a unit that homogenizes the light beam at least along a cross-sectional axis of the laser beam, a mask following downstream in the beam path of the light beam, said mask having mask regions that block the light beam and those that are transparent, and also an optical imaging unit disposed downstream in the beam path, in such a manner that the portion of the light energy which is blocked so as to remain unused for a further technical application should be reduced, without impairing the creative freedoms of the mask geometry in the process. It should in particular be achieved that, to the greatest extent possible, all of the light output contained in the homogenized light beam also remains retained after the passage through the mask.

The solution of the object on which the invention is based is specified in claim 1. An alternative device constructed in accordance with the solution is described in claim 11. A method in accordance with the solution is the subject of claim 17. The features which advantageously develop the idea in accordance with the solution are the subject of the subclaims and also to be drawn from the further description with reference to the exemplary embodiments.

The device in accordance with the solution for beam forming a homogenized light beam and with the features of the preamble of claim 1 stands out on account of the fact that an optical module is provided in the beam path between the homogenizing unit and the mask, said module imaging the entire cross section of the homogenized light beam largely without losses onto all transparent mask regions with uniform distribution.

Preferably, the optical module can image the homogenized light beam as a whole largely without losses and exclusively onto all transparent mask regions with uniform distribution, in order in this manner to ensure that the homogenized light beam which is beam formed by means of the mask geometry has light intensities with two-dimensionally uniform distribution.

By means of the construction of the optical module in accordance with the solution, which optical module images the homogenized light beam exclusively onto those regions of the mask which are transparently permeable for the light beam, the light energy losses connected with the previous use of masks can be clearly reduced so that, as a result, homogenized light beams with much less total energy need to be provided in order to provide light-exposure or illumination intensities comparable to the previous mask technology at the location of the technical application. With the concept in accordance with the solution, the requirements placed on the light sources can therefore be reduced so that with the use in accordance with the solution of the whole light energy contained within the homogenized light beam, an improvement of the light energy use of at least a factor of 10 compared to the previous mask technology can be achieved even after passing through the mask.

A further device alternative in accordance with the solution provides beam formation already within the homogenizing unit instead of beam formation in an optical module disposed downstream of the homogenizing unit in the beam path.

To this end, the homogenizing unit is constructed in the form of an optical integrator which has an entrance aperture and also an exit aperture, wherein the exit aperture is constructed under the condition of the transparent mask regions and images the overall cross section of the homogenized light beam largely without losses onto a transparent mask region or a plurality of transparent mask regions. The optical integrator is constructed in the manner of an optical waveguide, for example in the form of an internally mirrored tube, via one tube end of which the light beam enters via an entrance aperture and homogenizes itself by way of multiple reflections on the tube inner wall in the propagation direction along the tube. An exit aperture is provided at the other tube end, which for example is constructed in the form of a diaphragm with diaphragm regions which are transparent and blocking in the sense of reflective. The transparent diaphragm regions are adapted to the transparent mask regions in terms of form and arrangement. In addition to the tube inner wall, the entrance and exit apertures are also realized so as to be internally mirrored, so that those light portions which are initially hindered from exiting freely at the exit aperture are internally reflected at the latter and finally make it through the transparent light exit regions of the exit aperture by way of renewed multiple reflections.

In addition to the use of internally mirrored tubes, the use of rod-shaped optical waveguides consisting of transparent solid material is also conceivable, the circumferential curved surface of which optical waveguides is mirrored and/or the optical waveguide properties of which optical waveguide are based on suitably selected refractive index gradients. Even in the case of a construction variant of this type, suitably designed aperture shapes are installed at the rod-entrance and rod-exit surfaces, which aperture shapes are used for the previously described effect.

To describe possible technical exemplary embodiments for the optical module constructed in accordance with the solution, reference is made individually to the following figures.

### SHORT DESCRIPTION OF THE INVENTION

The invention is described by way of example in the following without limitation of the general inventive idea on the basis of exemplary embodiments with reference to the drawings. In the figures:

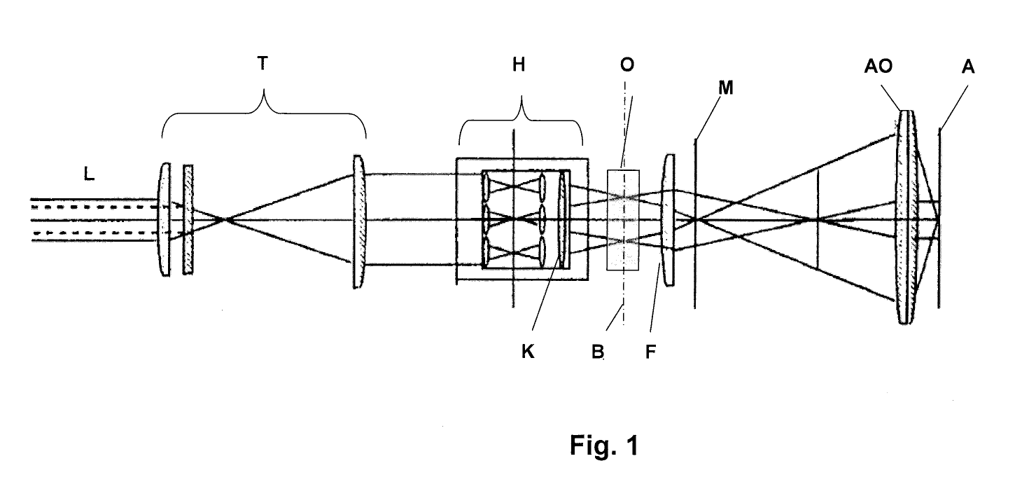

FIG. 1 shows a schematized representation of a light beam path containing a homogenizer with mask imaging onto a substrate surface,

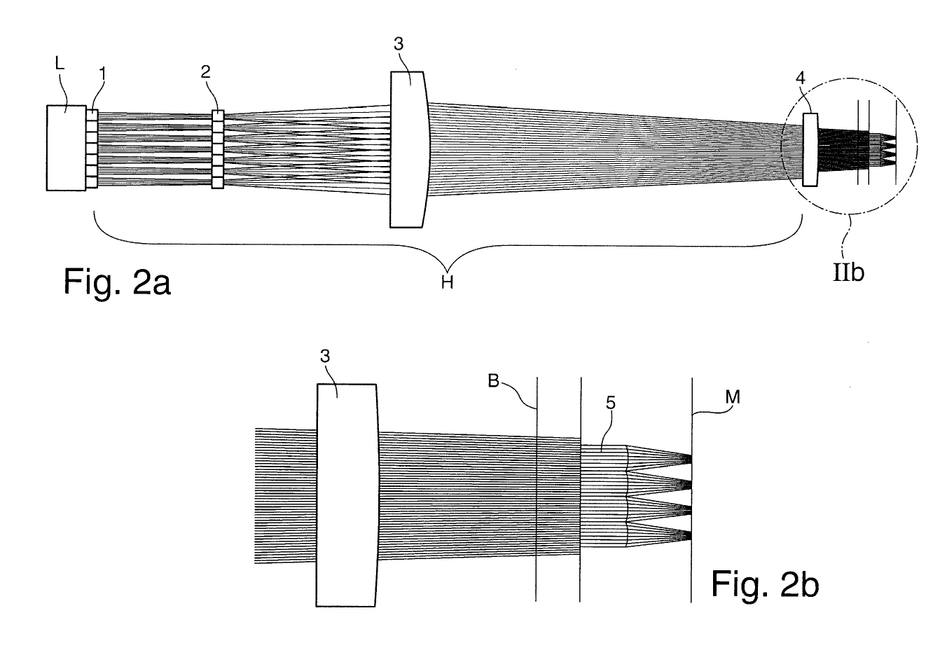

FIGS. 2a, b show a representation of a homogenizer with optic module disposed downstream for focussing the light beam onto transparent mask regions,

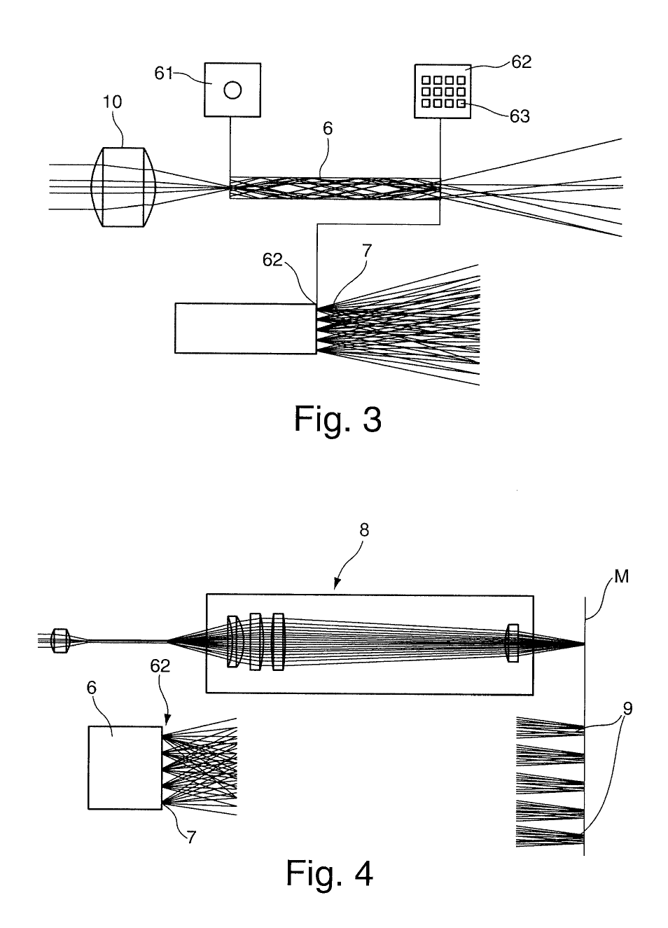

FIG. 3 shows a representation of a homogenizer of an optical integrator type, for forming a light beam adapted to the transparent mask regions, and also

FIG. 4 shows a representation of a homogenizer with optical imaging system disposed downstream.

### WAYS OF REALIZING THE INVENTION, INDUSTRIAL USABILITY

The whole beam path of a laser beam L is shown in FIG. 1 in a schematized manner, starting from a laser beam source, preferably an excimer laser (not shown) to the imaging of the laser beam into an imaging plane. A, in which a certain technical use of the laser beam L takes place.

The laser beam L passes through a telescopic lens arrangement T, which is not to be mentioned in further detail in the following, for adapting the beam to the entrance aperture of the homogenizer H. An optical module O is provided downstream in the beam path of the homogenizer H, which optical module can form the homogenized laser beam in the beam cross section in such a manner that the entire cross section of the homogenized light beam is imaged largely without losses exclusively onto the transparent mask regions of a mask M disposed downstream in the beam path. A field lens F positioned upstream of the mask M in the beam path is used to adapt the aperture diaphragm position of the optic disposed upstream of the mask M in the beam path to the entrance aperture diaphragm of an imaging optic AO disposed downstream of the mask M in the beam path, via which imaging optic the mask image is imaged onto an imaging plane A in which a substrate to be processed is normally placed.

The optical module constructed in accordance with the solution is preferably installed in the region of the homogeneous image plane B, into which the homogenizing unit H, in which a condenser lens K is additionally provided, images the laser beam which is forming in a homogenizing manner.

With reference to FIGS. 2a and b, a concrete embodiment for constructing the optical module is described in more detail. In FIG. 2a it may be assumed that the laser beam L coming from the left passes through a homogenizing unit H which is composed of a first cylindrical lens array 1, a second cylindrical lens array 2 and also two imaging lenses 3, 4. The four optical components 1, 2, 3, 4 form a homogenizer in accordance with the prior art which is known per se. The further description relates to the detailed illustration shown in FIG. 2b, which corresponds to the region which is surrounded by the dotted circle according to FIG. 2a. The homogenizer H can image the laser beam L into a homogenized image field plane B. A lens arrangement 5 is provided directly downstream of the latter in the beam path, which lens arrangement can further image the entire homogenized laser beam cross section. In the exemplary embodiment shown, it may be assumed that the lens arrangement 5 consists of a 4×4 lens array, wherein each individual lens of the lens array has a rectangular entrance aperture. The 4×4 rectangular lens arrangement has a correspondingly rectangular overall aperture which is adapted to the beam cross section of the homogenized light beam. On account of the seamless assembly of the individual lenses within the lens array, the entire beam cross section of the homogenized laser beam is imaged by means of the 4×4 lens arrangement onto the mask plane, in which the mask M is arranged. The imaging regions of the individual lenses coincide with the transparent mask regions of the mask M.

Preferably, all of the lenses in the lens arrangement 5 have an identical cross section so that the individual focal points in the mask plane are illuminated with the same light intensity in each case. As a result, a regular mask pattern, which preferably provides punctiform openings or small rectangular openings in the otherwise non-transparent mask surroundings, is obtained with increased light intensity compared to previous mask illuminations, wherein no light loss occurs due to blocking mask regions in accordance with the solution.

When using rectangular and non-square entrance apertures in the case of the individual lenses in the lens arrangement 5, illumination patterns can be generated in the mask plane with a different “pitch” for the two orthogonal beam cross section directions on the mask, which illumination patterns can advantageously be used in different technical fields of application.

A further possibility for the selective imaging of a homogenized light beam onto local regions in the mask plane is shown in FIG. 3. So, it may initially be assumed that a light beam L in already homogenized form impinges from the left onto the rod-shaped or tubular arrangement 6. For example, it may be assumed that the tubular arrangement is constructed as a hollow tube whose tube inner wall has a reflective coating. The entrance aperture 6 is adapted to the cross section of the incident homogenized laser beam L and likewise internally mirrored. This is illustrated in FIG. 3 with the pinhole diaphragm arrangement 61. The laser beam propagating along the tube 6 is subjected to a further homogenization by means of multiple reflections on the tube inner wall. The exit aperture of the tube 6 is determined by means of an exit mask 62 which has a multiplicity of individual exit openings 63 which are adapted to the transparent mask regions of a mask not shown in FIG. 3 and disposed downstream in the beam path. The detailed illustration in FIG. 3 clarifies the beam exit at the exit aperture 62 of the tube 6 and shows an exit of a multiplicity of separated light beams 7.

In FIG. 4, an optical intermediate imaging unit 8 is disposed downstream of the exit aperture 62 of the tube 6 in the beam path, through which optical intermediate imaging unit the multiplicity of the separated beams 7 are imaged onto transparent mask regions 9 in a focussed manner.

The unit 6 constructed in a rod-shaped or tubular manner in FIG. 3 already constitutes a homogenizer which in itself is known per se however, which can be used for homogenizing incident laser light L. Subsequently, with reference once more to the exemplary embodiment in FIG. 3, it is therefore assumed that the laser beam L incident from the left has not yet undergone homogenization and is imaged onto the entrance aperture 61 of the tubular or rod-shaped unit 6 already described previously merely via an imaging optic 10. The inner surfaces of the entrance and exit apertures 61, 62 and also of the inner wall surface of the tube 6 are constructed in a mirrored manner so that those light portions which do not make it through the openings 63 of the exit aperture 62 are reflected back within the tubular unit 6 until they finally make it through the corresponding exit openings 63. As long as light reflected back within the tube 6 is reflected again at the inner entrance surface, the said light makes it once more to the exit surface 62 and can exit to some extent through the exit openings 63. Thus, a homogenizer modified in this manner can let light pass through in those regions of the further beam path which coincide with the transparent mask regions of a mask M disposed downstream in the beam path.

### REFERENCE LIST

1 First cylindrical lens arrangement
2 Second cylindrical lens arrangement
3, 4 Imaging lenses
5 Lens array arrangement
6 Homogenizer constructed in a rod-shaped or tubular manner
61 Entrance aperture
62 Exit aperture
63 Exit aperture openings
7 Separated light beams
8 Optical unit disposed downstream
9 Transparent mask regions
10 Imaging optic
M Mask
B Homogenized image field plane
H Homogenizer
L Laser beam
T Telescopic arrangement
O Optical module
AO Imaging optic
A Imaging plane
F Field lens
K Condenser lens

1-17. (canceled)

18. A device for forming a homogenized light beam, comprising:
a unit for homogenizing a cross section of the light beam into a uniform distribution at least along a cross-sectional axis of the light beam;
a mask located downstream from the unit in a path of the light beam, including a plurality of mask regions that block the light beam and a plurality of mask regions that are transparent to the light beam; and
an optical module disposed in the beam path, between the unit for homogenizing the light beam and the mask, said optical module for creating an image of the light beam arranged so that it is primarily directed to impinge on the mask only in the transparent regions thereby minimizing losses at the blocking regions.

19. A device according to claim 18, wherein the optical module has an entrance aperture which is adapted to the beam cross section of the homogenized light beam.

20. A device according to claim 18, further including a telescopic lens system in the path of the light beam upstream of the optical module, which adapts the homogenized light beam to an entrance aperture of the optical module.

21. A device according to claim 18, wherein the optical module has at least one imaging lens through which the homogenized light beam is imaged onto the mask.

22. A device according to claim 18, wherein the optical module includes an arrangement of imaging lenses having rectangular apertures with the lenses being disposed in an array and defining a two-dimensional contiguous entrance aperture for the optical module.

23. A device according to claim 22, wherein each of the lenses are the same.

24. A device according to claim 18 wherein the homogenizing unit includes a condenser optic which images a cross section of the light beam into a homogeneous image field plane and wherein the optical module is disposed proximate to a location of the homogeneous image field plane.

25. A device according to claim 18, wherein the optical module includes an optical integrator with an entrance aperture and an exit aperture and wherein the exit aperture of the optical integrator is configured to image the light into the mask.

26. A device according to claim 25, comprising an optical imaging system disposed downstream of the optical integrator in the beam path which images at least one light beam generated by the exit aperture of the integrator onto the mask.

27. A device according to claim 25, wherein the optical integrator comprises a rod or hollow integrator along which the light beam propagates in the direction of the beam by reflection on a limit surface adjoining the integrator.

28. A device according to claim 25, wherein the exit aperture includes an exit mask which has a pattern of transparent and blocking regions corresponding to the pattern of the downstream mask.

29. A device according to claim 18, wherein the light beam is from an excimer laser.

30. A device for forming a homogenized light beam, comprising:
a unit for homogenizing a cross section of the light beam, the homogenizing unit being an optical waveguide integrator including an entrance aperture and an exit aperture; and
a mask located downstream from the unit in a path of the light beam, including a plurality of mask regions that block the light beam and a plurality of mask regions that are transparent to the light beam and wherein the exit aperture of the homogenizer is arranged to create an image of the light beam arranged so that it is primarily directed to impinge on the mask only in the transparent regions thereby minimizing losses at the blocking regions.

31. A device according to claim 30, wherein an optical imaging system is disposed downstream of the optical integrator in the beam path for imaging the exit aperture of the integrator onto the transparent mask regions.

32. A device according to claim 30, wherein the optical integrator comprises a rod or hollow integrator along which the light beam propagates in a beam direction by reflection on a limit surface adjoining the integrator.

33. A device according to claim 30, wherein the exit aperture is defined by an exit mask and wherein the exit mask which has a pattern of transparent and blocking regions corresponding to the pattern of the downstream mask

34. A device according to claim 30, wherein the light beam is from an excimer laser.

35. A method for forming a homogenized light beam for imaging on a mask, said mask including a plurality of mask regions that block the light beam and a plurality of mask regions that are transparent to the light beam, said method comprising the steps of:
homogenizing a light beam at least along a cross-sectional axis of the light beam; and
imaging the homogenized light beam so that it is primarily directed to impinge on the mask only in the transparent regions thereby minimizing losses at the blocking regions.
